(19) United States
(12) Patent Application Publication
(10) Pub. No.: US 2006/0096961 A1
(43) Pub. Date: May 11, 2006

(54) Method for manufacturing a wire and a wire

(75) Inventors: Martti Kahkonen, Sotkamo (FI); Timo Tapani Sirvio, Sotkamo (FI); Arja Hannele Keikanen, Kajaani (FI); Juha Pekka Vainikainen, Kajaani (FI)

Correspondence Address: OLIFF & BERRIDGE, PLC, P.O. BOX 19928, ALEXANDRIA, VA, 22320, US

(73) Assignee: Metso Automation Oy, Helsinki (FI)

(21) Appl. No.: 10/513,401

(22) PCT Filed: May 14, 2003
(86) PCT No.: PCT/FI03/00373

§ 371 Date: Aug. 4, 2005

(30) Foreign Application Priority Data
May 15, 2002 (FI) 20020915

(51) Int. Cl. B23K 26/38

(52) U.S. Cl. 219/121.72; 219/121.71

(57) ABSTRACT

The invention relates to a method for manufacturing a wire used in standard freeness measuring of paper stock and a wire according to the manufacturing method. In the solution, a means for producing holes (210), which is something else than a solid, is directed on a wire plate (18) at areas intended for desired holes (210). The wire plate (18) is provided with the holes using the means for producing holes (210).

### FIELD

The invention relates to a wire and a method for manufacturing a wire.

### BACKGROUND

In order to make high-quality paper, the properties of paper stock have to be accurately measured and adjusted. In measuring the freeness of paper stock, the speed by which paper stock can be separated from water is empirically determined. Freeness depends on several factors, such as fibres, stock processing (mechanical/chemical, for example), the quantity of fines, temperature, consistency, and the measuring device.

Most common methods for measuring freeness are CSF (Canadian Standard Freeness) and the Schopper-Riegler method. In both freeness-measuring methods, a sample is filtered through a wire into a funnel comprising a constant-flow valve and a lateral branch. The water removed from the lateral branch is measured and the amount of water obtained corresponds to freeness. The measuring is typically performed manually.

What causes problems in such measurings is the wire. According to standard, the wire includes holes with a diameter of 0.51 mm and the density of the holes is 625 holes per square inch, which corresponds to approximately 97 holes per square centimetre. The holes in a standard wire are made using a mechanical punching machine. In punching, a cutting edge is used to punch holes into the wire. Hence, the different sides of the wire become different. When punching is carried out, the wire bends, and in the punching direction, a sharp edged burr remains around the holes on the lower surface of the wire. Consequently, the use of the wire becomes complicated and the chance for errors increases, since in freeness measuring the wire has to be placed so that the side that provides burr remains downwards. In addition, the spread of the distances between the holes and the diameters of the holes is large, which together with the above-mentioned problems result in that different wires provide significantly deviating freeness results for the same sample. Attempts have been made to reduce the deviations in measurings carried out with different wires by comparing the wires to what is known as a master wire. However, the problem cannot be solved in this way.

### BRIEF DESCRIPTION

It is an object of the invention to provide an improved method for manufacturing a wire, and a wire enabling to measure freeness accurately and irrespective of the side on which the wire is placed for measuring. This is achieved with the method for manufacturing a wire used in standard freeness measuring of paper stock. The method comprises: directing a means for producing holes, which is something else than a solid, on a wire plate at areas intended for desired holes; and providing the wire plate with such holes using the means for producing holes.

The invention also relates to a wire used in standard freeness measuring of paper stock. Furthermore, the wire is made by directing a means for producing holes, which is something else than a solid, on a wire plate at areas intended for desired holes; and providing the wire plate with such holes using the means for producing holes.

Preferred embodiments of the invention are disclosed in the dependent claims.

The invention is based on the idea that the wire holes are made into the wire using a means, which is not a solid. Thus, the wire holes are made equal on both sides of the wire and no burr remains on the wire. In addition, during the manufacturing stage the wire is not mechanically subjected to strain.

The manufacturing method and the wire of the invention provide several advantages. The wire is alike on both sides thereof, and therefore the same result is obtained in the freeness measuring irrespective of which side of the wire is placed downwards. In addition, different wires provide an equal freeness result from the same sample. Furthermore, the manufactured wires need no longer be compared with what is known as a master wire, since the wires can be made exactly alike.

### LIST OF DRAWINGS

In the following, the invention will be described in more detail by means of the preferred embodiments with reference to the accompanying drawings, in which

FIG. 1 shows standard freeness measuring,

FIG. 2A shows a resist on the wire,

FIG. 2B shows exposing a photoresist,

FIG. 2C shows a patterned resist on the wire,

FIG. 2D shows etching of the wire,

FIG. 3 shows laser cutting,

FIG. 4 shows water cutting, and

FIG. 5 shows electrical discharge machining.

### DESCRIPTION OF PREFERRED EMBODIMENTS

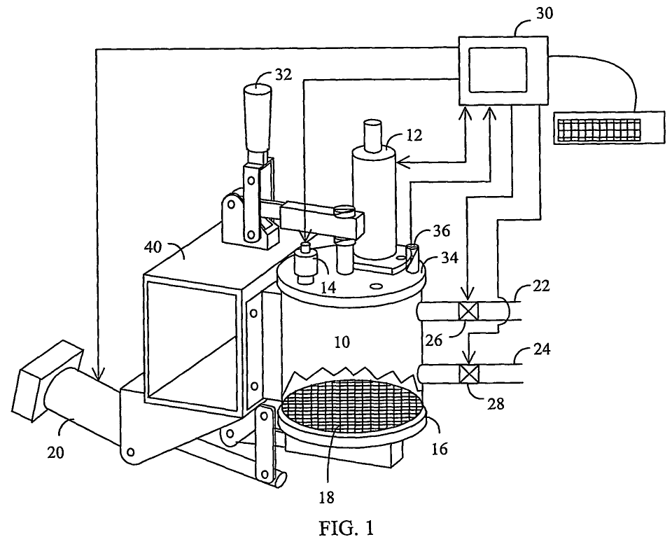

Let us first take a closer look at prior art freeness measurings. The CSF measuring method shown in FIG. 1 is a standard and has been described in detail in publication T 227 om-94, Freeness of pulp, TAPPI, 1994, which is incorporated herein by reference. In the CSF measuring, the freeness of paper stock is measured from a sample, the consistency of which is 0.3% and the temperature is 20° C. If the consistency or temperature of the sample differs from the determined values, the freeness result is amended according to predetermined table values so that the measurement corresponds to the determined consistency and temperature values. In the beginning of the CSF measuring, precisely one litre of the sample is measured into a measuring container 10 comprising container walls, an upper lid 36 that closes against the top part of the walls, a wire 18 at the bottom of the container, a lower lid 16 that closes against the bottom part of the walls and an air valve 14. The lower lid 16 is opened and the sample is allowed to be placed in the container, whereby some of the stock descends on the wire 18 at the bottom of the container. After about 5 seconds from opening the lower lid 16, the air valve is opened and water starts to be removed from the stock sample through the wire 18 and the stock piled on the wire.

In the standard basic solution, the water flows further into a funnel comprising a constant flow nozzle at the bottom of the funnel and a lateral tube in the bottom part of the funnel. A constant volume (24.2 ml) remains in the funnel between the constant flow nozzle (constant flow 8.83 ml/s) and the lateral tube. When water flows from the measuring container into the funnel, some of the water flows out through the constant flow nozzle, a constant volume (24.2 ml) of water is collected between the constant flow nozzle and the lateral tube, and finally water flows out through the lateral tube. In freeness measuring, the amount of water that has flown out through the lateral tube is measured using a measuring glass and said amount of water corresponds to freeness. The measuring is typically carried out manually.

Alternatively, freeness can also be measured in an automated manner. Thus, a measuring chamber 10 in the measuring device is attached to a supporting structure 40. In the beginning of the measuring, the measuring chamber 10 is filled with paper stock to be measured. Filling may either be carried out manually by opening an upper lid 34 using a lever 32 and pouring paper stock into the measuring chamber 10 or automatically from a tube 22. However, manual filling is not worth using in industrial processes and the manual opening mechanism of the upper lid is therefore not relevant. When filling is carried out through the tube 22, an automatic data processing unit 30, for instance a computer comprising a microprocessor, provides a command to open a valve 26, whereby paper stock flows into the measuring chamber 10. When the measuring chamber 10 is filled, a lower lid 16 is opened using an opening mechanism 20. After opening the lower lid 16, an air valve 14 is opened after a predetermined delay of typically 5 seconds at time instant T0. Opening the lower lid 16, measuring the delay and controlling the opening of the air valve 14 are accurately carried out by the automatic data processing unit 30. The measuring device comprises measuring means 12 for measuring the removal of liquid from the measuring chamber as a function of time after opening the air valve. Liquid flows through a wire 18 leaving the solid in the paper stock on the wire 18. The drainage of liquid is measured with a sensor 12 comprising for instance a pair of optic transmitters/receivers or one based on ultrasound. The sensor 12 is connected to the automatic data processing unit 30. Measuring is carried out for example in such a manner that the optic or acoustic transmitter transmits a measuring signal towards the surface of the paper stock, from where the signal is reflected to the optic or acoustic receiver. When the location of the transmitter and receiver is known as well as the propagation time of the signal from the transmitter to the receiver, the height of the surface can be determined. The sensor 12 feeds the measuring data concerning the propagation time of the signal into the automatic data processing unit 30, which determines the flow rate. The automatic data processing unit 30 establishes by means of the collected measuring data the freeness F in such a manner that the water in the paper stock is allowed to flow through the wire 18 at time instant T0. When the flow starts at time instant T0 the decrease of paper stock is measured in the measuring chamber 10 as a function of time, and such a time instant T1 is searched for, in which the decrease of paper stock substantially corresponds to a previously known flow rate v_{c}. Finally, the freeness F is determined as a function of the amount of liquid drained from the measuring chamber 10 by time instant T1. This standard freeness measuring, into which the wire of the solution is applicable, is described in more detail in Finnish patent 104855.

A method known as the Schopper-Riegler method is described in publication SCAN-C 19:65, Scandinavian pulp, paper and board, Testing committee, approved 1964, which is incorporated herein by reference (no Figures of this method are shown). According to this standard method, a known quantity of paper stock is first poured on a locking cone, which is opened after a predetermined period of time (5 s). The stock is then filtered through a wire and a fibre matting piling on the wire into a funnel provided with an opening at the bottom and side thereof. Water flows out through the bottom opening at a constant flow rate [1000 ml(149 s±1)≈6.71 ml/s]. A constant volume (7.5 ml-8.0 ml) remains between the bottom opening and the side opening. The amount of water flowing through the side opening corresponds to the freeness measured in SR units so that 0 ml corresponds to 100 SR units, 1000 ml corresponds to 0 SR units and one SR unit thus corresponds to 10 ml. The SR and CSF scales are opposite to one another, meaning that a high SR value corresponds to a low CSF value. This measuring is also generally carried out manually.

The wire required in freeness measuring may be a perforated plate. In accordance with the presented solution, the wire required in standard measuring is made by directing a means for producing holes, which is something else than a solid, on a wire plate at areas intended for desired holes, and the holes on the wire plate are provided using the means for producing holes. The methods may include etching, laser cutting or water cutting, in which the means producing holes is a corrosive liquid, radiation or a liquid jet. The wire can also be made using two or more of the manufacturing methods. Since the means employed for producing holes is not a solid, neither the wire plate nor the holes to be provided will be deformed when the holes are made. The wire is made of a plate-like object, which may be metal, plastic, glass, ceramic material or the like. Metals that can be used include for instance copper and acid steel. The wire plate may generally be made of any material, for which the different stages of the manufacturing process and freeness measuring can be carried out.

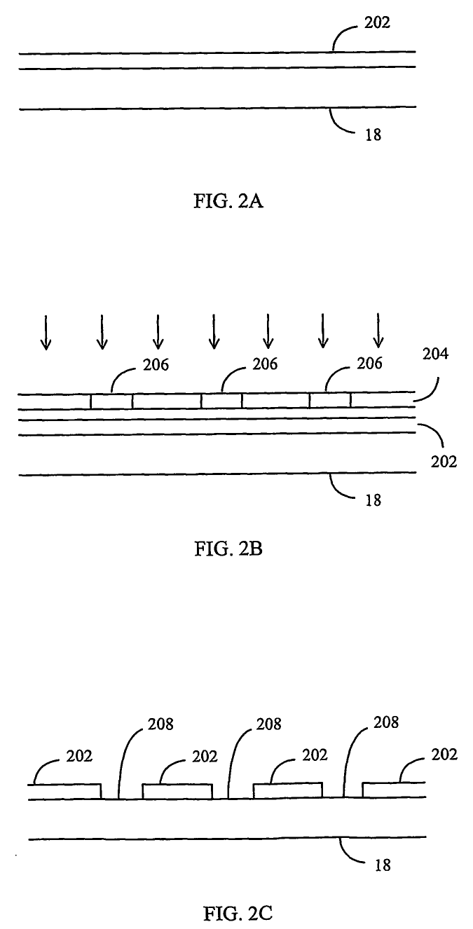

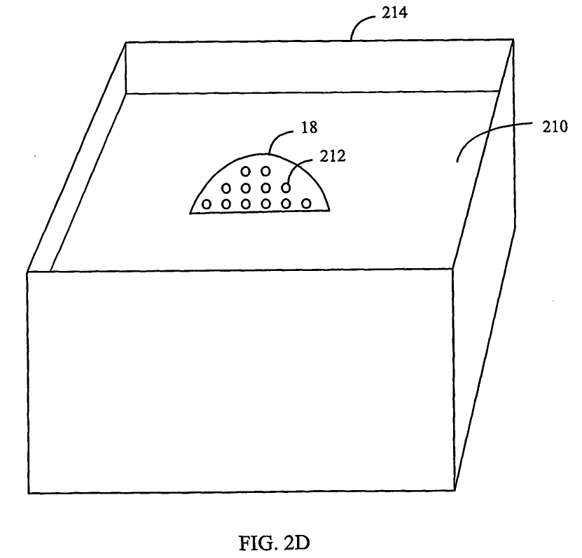

Let us first take a closer look at etching shown in FIGS. 2A to 2D. A wire plate 18 may be cut at first according to correct external measures or it may be larger than the wire to be produced, whereby the wire plate will be cut after the holes have been made. Both sides of the wire plate 18 are provided with a photoresist 202 in accordance with FIG. 2A. The photoresist may be either a negative photoresist or a positive photoresist. A negative photoresist hardens when subjected to exposure, whereas a positive photoresist does not harden when exposed. The photoresist 202 is patterned by means of a mask 204 and radiation. When the negative photoresist is used, the mask 204 comprises areas 206 preventing radiation at the places where the wire holes will be provided. Correspondingly, when the positive photoresist is concerned, the mask is provided with areas allowing radiation at the places, where the wire holes will be provided. When exposure has been carried out, the photoresist is developed and the non-hardened parts of the photoresist are washed away, whereby the photoresist 202 otherwise protects the wire plate 18 except for the areas 208 of the holes to be provided. Thereafter, the wire plate 18 including the photoresists is embedded into an etching basin 214, in which a corrosive agent 210 corrodes the holes 212 into the non-photoresist areas of the wire 18. Etching can be carried out from one side of the wire of from both sides thereof. When etching is performed from only one side of the wire, the areas of the holes need not be aligned with the areas of the holes on the opposite side, whereas etching is faster and of higher quality when it is carried out on both sides.

Etching provides holes of desired sizes extremely accurately, and the spread of the distances between the holes is very small. Differences between the holes (for instance between 10 holes) on known wires, measured using triangulation, range between 1.05 mm and 1.19 mm, whereas a corresponding spread between holes on the wires according to the solution is difficult to detect, while the spread is at the most ±0.02 mm. Etching hardly puts any strain upon the wire plate, and the shape of the wire plate therefore remains unchanged. It is particularly important that no burrs are formed. A wire manufactured in this way can be placed for standard measuring on either side.

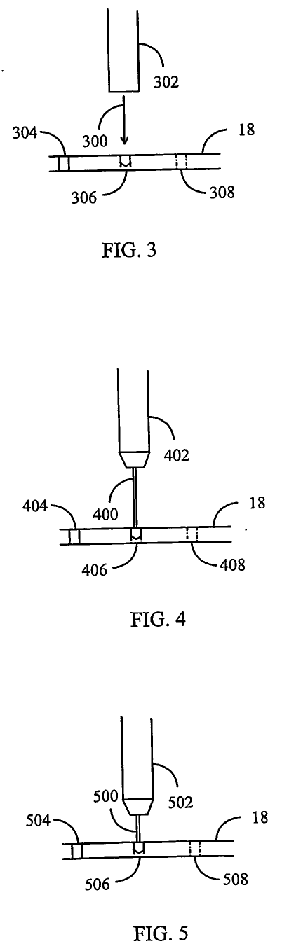

Let us now take a closer look at laser cutting shown in FIG. 3. A high-powered laser beam 300 is directed from a transmitter 302 to the areas of the wire plate 18, where the holes are desired to be provided. The laser beam 300 cuts holes into the wire plate 18 as desired, one hole at a time. In FIG. 3, a hole 304 is already provided, a hole 306 is being provided and a hole 308 will next be provided. Laser cutting can be used for making holes accurately for instance by means of CAD technique. The outcome is smooth, even without post-cutting. Since cutting is carried out rapidly and the cutting energy of the laser beam is directed to a small area, the wire plate will not heat and therefore not change the shape thereof. It is extremely important to notice that no burrs are formed. A wire manufactured in this way can be arranged for standard freeness measuring on either side.

Let us further take a closer look at water cutting shown in FIG. 4. In water cutting, the wire plate 18 is subjected to a narrow water jet 400 (with a diameter of tenths of millimetres at the most) at high pressure (even up to hundreds of MPa) from a nozzle 402. The water jet may be provided, if necessary, with abrasive particles (especially when cutting hard substances). In the same way as in laser cutting, the water jet 400 cuts holes into the wire plate 18 as desired, one hole at a time. In FIG. 4, a hole 404 is already cut, a hole 406 is being cut and a hole 408 will next be cut. Also in this case, the outcome is smooth, even without post-cutting. Since cutting is carried out rapidly and the water jet is directed to a small area, the wire plate will not change the shape thereof. It is particularly important to note that no burr is formed. A wire manufactured in this way may be arranged for standard measuring on either side.

Laser and water cutting can be combined to take place simultaneously, whereby laser water cutting is concerned. In such a case, the laser beam is directed to the wire plate either along a water jet or from a different direction with respect to the water jet. Both the water jet and the laser beam can together cut the holes on the wire plate. Alternatively or in addition to, the water jet may function as a means for cooling the wire plate, thus reducing the strain of the wire plate and the possible changes in appearance. When the water jet operates merely as cooling means, cutting is performed using the laser beam.

Instead of laser and water cutting or in addition thereto, the wire may be manufactured using electrical discharge machining (EDM) described in FIG. 5. For example, plunge EDM or wire EDM can be used as electrical discharge machining. In this manufacturing method, the wire plate 18 is placed into a liquid medium (not shown in FIG. 5) provided with poor electrical conductivity. Wire holes 504, 506 are achieved with electric discharges, which provide sparks 500 from an electrode 502 to a wire billet. The sparks 500 are created on the field of the entire electrode and the sparks heat up the area of the hole on the wire, thus melting and evaporating the wire material and removing the wire material to the medium from the areas where the sparks hit. In FIG. 5, the hole 504 is already completed, the hole 506 is being made and the hole 508 will next be made. The shape of the electrode 502 may have an effect on the size and shape of the hole.

The wire can also be treated mechanically. Such measures include cutting, grinding and polishing.

Even though the invention has above been explained with reference to the example in the accompanying drawings, it is apparent that the invention is not restricted thereto but can be modified in various ways within the scope of the inventive idea disclosed in the appended claims.

1-17. (canceled)

18. A method for manufacturing a wire used in standard freeness measuring of paper stock the method comprising:
directing a means for producing holes, which is something else than a solid, on a wire plate at areas intended for desired holes; and
providing the wire plate with the holes using the means for producing holes.

19. A method as claimed in claim 18, the method further comprising making the wire by etching, whereby the means for producing holes is a substance corroding the wire plate.

20. A method as claimed in claim 19, the method further comprising forming a resist on the wire plate surface during etching, said resist is provided with holes, and filtering holes of the wire plate are etched at the holes of the resist.

21. A method as claimed in claim 19, the method further comprising spreading a resist, which is a photoresist, on the wire plate surface during etching, exposing the photoresist using a mask, developing the photoresist, whereby providing the photoresist with holes, and etching the filtering holes on the wire plate at the holes of the resist.

22. A method as claimed in claim 18, wherein the wire plate is made of metal.

23. A method as claimed in claim 18, the method comprising forming the filtering holes of the wire using laser cutting, whereby the means for producing holes is a laser beam.

24. A method as claimed in claim 18, the method further comprising forming the filtering holes of the wire using water cutting, whereby the means for producing holes is a water jet.

25. A method as claimed in claim 18, the method further comprising forming the filtering holes of the wire using a combination of laser cutting and water cutting, whereby the means for producing holes is a combination of a water jet and a laser beam.

26. A method as claimed in claim 18, the method further comprising cutting a wire plate into a wire of desired size.

27. A wire used in standard freeness measuring of paper stock, wherein the wire is made by
directing a means for producing holes, which is something else than a solid, on a wire plate (18) at areas intended for desired holes; and providing the wire plate with the holes using the means for producing holes.

28. A wire as claimed in claim 27, wherein the wire is made by etching, whereby the means for producing holes is a substance corroding the wire plate.

29. A wire as claimed in claim 28, wherein a resist is formed on the wire plate surface during etching, said resist is provided with holes, and filtering holes of the wire plate are etched at the holes of the resist.

30. A wire as claimed in claim 28, wherein a resist, which is a photoresist, is spread on the wire plate surface during etching, the photoresist is exposed using a mask, the photoresist is developed, whereby the photoresist is provided with holes, and the filtering holes are etched on the wire plate at the holes of the resist.

31. A wire as claimed in claim 27, wherein the wire plate is made of metal.

32. A wire as claimed in claim 27, wherein the filtering holes of the wire are formed using laser cutting, whereby the means for producing holes is a laser beam.

33. A wire as claimed in claim 27, wherein the filtering holes of the wire are formed using water cutting, whereby the means for producing holes is a water jet.

34. A wire as claimed in claim 27, wherein the filtering holes of the wire are formed using a combination of laser cutting and water cutting, whereby the means for producing holes is a combination of a water jet and a laser beam.
